(19) United States
(12) Patent Application Publication
(10) Pub. No.: US 2021/0159832 A1
(43) Pub. Date: May 27, 2021

(54) MOTOR CONTROLLER

(71) Applicant: AISIN SEIKI KABUSHIKI KAISHA, Kariya-shi (JP)

(72) Inventors: Naoki ONOSAKA, Kariya-shi (JP); Misato MAEDA, Kariya-shi (JP); Genki YAMASHITA, Kariya-shi (JP); Yuka FUKADA, Kariya-shi (JP)

(73) Assignee: AISIN SEIKI KABUSHIKI KAISHA, Kariya-shi (JP)

(21) Appl. No.: 17/097,455

(22) Filed: Nov. 13, 2020

(30) Foreign Application Priority Data
Nov. 21, 2019 (JP) 2019-210237

(51) Int. Cl. H02P 21/34; H02P 21/36

(52) U.S. Cl. CPC H02P 21/34; H02P 21/36

(57) ABSTRACT

A motor controller includes a power supply controller controlling a power supply to rotate a rotor to a predetermined position by supplying power to an excitation coil of a predetermined phase among excitation coils of three phases of the rotor at startup of the rotor, the power supply controller selecting the excitation coil of the predetermined phase to which power is supplied in accordance with a position of a magnetic pole of the rotor in a state where the rotor is stopped.

### CROSS REFERENCE TO RELATED APPLICATIONS

This application is based on and claims priority under 35 U.S.C. § 119 to Japanese Patent Application 2019-210237, filed on Nov. 21, 2019, the entire content of which is incorporated herein by reference.

### TECHNICAL FIELD

This disclosure generally relates to a motor controller.

### BACKGROUND DISCUSSION

A known motor controller that performs and controls one-phase power supply for rotating a rotor to a predetermined position at startup of the rotor is disclosed in JP2018-33271A (which is hereinafter referred to as Reference 1), for example.

Specifically, the motor controller disclosed in Reference 1 controls a brushless motor including three-phase excitation coils (i.e., U-phase, V-phase, and W-phase excitation coils). The motor controller is configured to power the U-phase excitation coil of the three-phase excitation coils for a predetermined time period at startup of the brushless motor. This causes N poles to be formed at leading ends of U-phase slots opposed to the rotor. The rotor rotates and stops at the predetermined position accordingly. At this time, induced voltage is generated at the V-phase excitation coil and the W-phase excitation coil, which is caused by the rotation of the rotor. Then, the induced voltage generated at each of the V-phase excitation coil and the W-phase excitation oil is measured. In a case where the induced voltage is relatively high, it is determined that a starting performance of the rotor is appropriate and the rotor is able to start. In a case where the induced voltage is relatively low, it is determined that the rotor is unable to start. When it is determined that the rotor is able to start, a forced commutation control is started for supplying power to a predetermined excitation coil in a predetermined power supply method. When it is determined that the rotor is impossible to start, power is supplied to the excitation coil other than the aforementioned predetermined excitation coil to start the forced commutation control. The rotor is forcedly rotated accordingly.

Nevertheless, depending on the position of the rotor of the motor where the known one-phase power supply such as disclosed in Reference 1 is performed, the rotor may not rotate to the predetermined position (fixed position). Specifically, in a case where the rotor is located at the position where a magnetic pole of the rotor and a magnetic field generated from the U-phase excitation coil on which the one-phase power supply is performed are balanced out, the rotor is inhibited from rotating to the predetermined position. In this case, the induced voltage is not generated at the other coils than the coil on which the one-phase power supply is performed. Whether the rotor is able to start is thus not accurately determined. The rotor may lose steps because the excitation coil to which power should be supplied in the forced commutation control is not appropriately selected.

A need thus exists for a motor controller which is not susceptible to the drawback mentioned above.

### SUMMARY

According to an aspect of this disclosure, a motor controller includes a power supply controller controlling a power supply to rotate a rotor to a predetermined position by supplying power to an excitation coil of a predetermined phase among excitation coils of three phases of the rotor at startup of the rotor, the power supply controller selecting the excitation coil of the predetermined phase to which power is supplied in accordance with a position of a magnetic pole of the rotor in a state where the rotor is stopped.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a motor according to an embodiment disclosed here;

FIG. 2 is a block diagram of a motor controller that controls the motor according to the embodiment;

FIGS. 3A-3C are explanatory views for explaining a magnetic pole direction, an applied voltage, and a current change rate;

FIGS. 4A-4C are also explanatory views for explaining the magnetic pole direction, the applied voltage, and the current change rate;

FIG. 5 is an explanatory view for explaining the applied voltage, a measured current, the current change rate, and a polar signal;

FIG. 6 is a diagram illustrating a relation between a q-axis, a qc-axis, a d-axis, and a dc-axis according to the embodiment;

FIG. 7 is a diagram illustrating a relation between a displaced angle and the polar signal;

FIGS. 8A and 8B are diagrams illustrating a relation between the q-axis, the qc-axis, the d-axis, and the dc-axis in a case where the displaced angle is equal to or greater than zero degree and smaller than 90 degrees;

FIGS. 9A and 9B are diagrams illustrating a relation between the q-axis, the qc-axis, the d-axis, and the dc-axis in a case where the displaced angle is equal to or greater than 90 degrees and smaller than 180 degrees;

FIGS. 10A and 10B are diagrams illustrating a relation between the q-axis, the qc-axis, the d-axis, and the dc-axis in a case where the displaced angle is equal to or greater than minus 180 degrees and smaller than minus 90 degrees;

FIGS. 11A and 11B are diagrams illustrating a relation between the q-axis, the qc-axis, the d-axis, and the dc-axis in a case where the displaced angle is equal to or greater than minus 90 degrees and smaller than zero degree;

FIGS. 12A and 12B are diagrams explaining a one-phase power supply in a case where a magnetic pole is arranged in a dead spot; and

FIG. 13 is a flowchart explaining the operation of the motor controller according to the embodiment.

### DETAILED DESCRIPTION

An embodiment is explained with reference to the attached drawings.

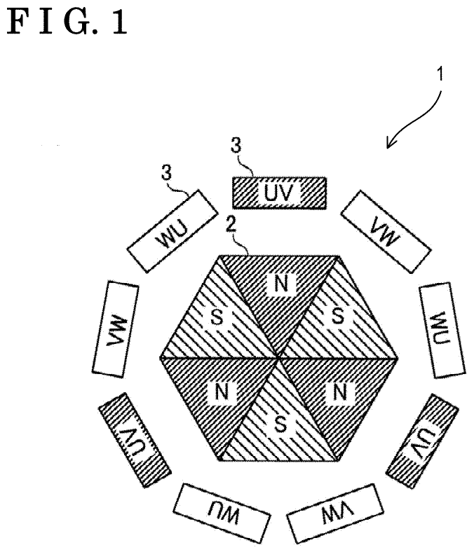

First, the construction of a motor controller 100 is explained with reference to FIGS. 1 to 13. The motor controller 100 is configured to control a motor 1 (control a rotation of a rotor 2) with a vector control.

The motor 1 controlled by the motor controller 100 is explained with reference to FIG. 1. The motor 1 is constituted by a sensor-less brushless motor. The motor 1 includes plural permanent magnets (for example, 6-pole magnets). The motor 1 is an interior permanent magnet (IPM) motor where permanent magnets are embedded in the rotor 2 or a surface permanent magnet (SPM) motor where permanent magnets are arranged at a surface of the rotor 2, for example. The motor 1 is used for an electric water pump, for example.

The motor 1 also includes plural excitation coils 3. The plural excitation coils 3 include U-phase, V-phase, and W-phase excitation coils 3. Such excitation coils 3 are connected via Y-connection or delta-connection. Electric current flows through any of U-phase to W-phase excitation coils 3, V-phase to W-phase excitation coils 3, and W-phase to U-phase excitation coils 3 accordingly.

The construction of the motor controller 100 is explained below.

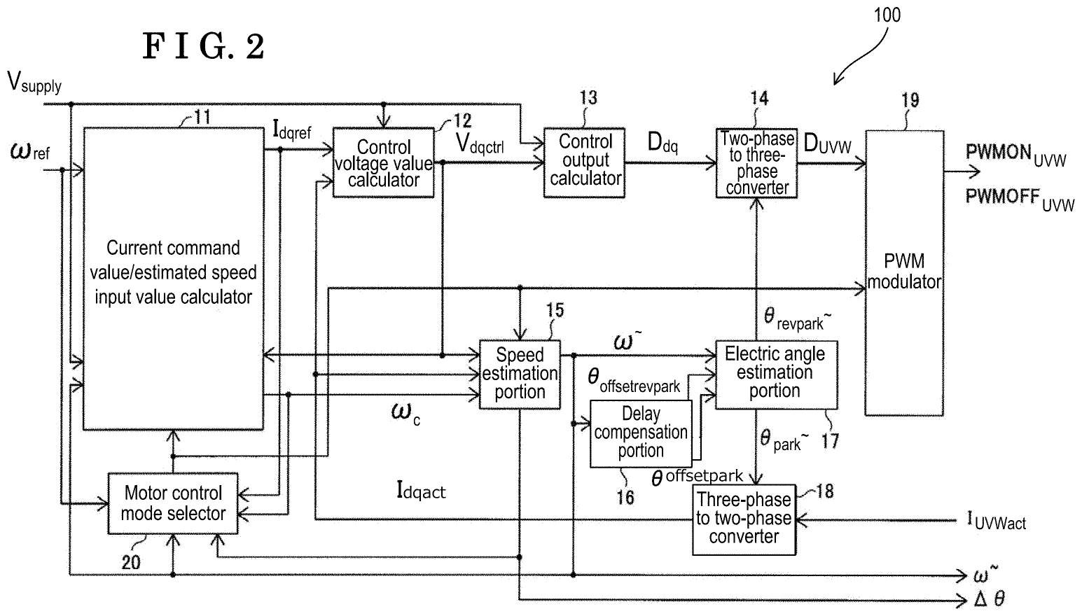

As illustrated in FIG. 2, the motor controller 100 includes a current command value/estimated speed input value calculator 11. The current command value/estimated speed input value calculator 11 receives a speed command value ω_{ref} from an upper level controller. The upper level controller sends a power supply voltage V_{supply} to the current command value/estimated speed input value calculator 11, a control voltage value calculator 12, and a control output calculator 13. The current command value/estimated speed input value calculator 11 calculates a d-axis/q-axis current command value I_{dqref} and an estimated speed input value ω_{c} based on the speed command value ω_{ref} input to the current command value/estimated speed input value calculator 11.

The motor controller 100 includes the control voltage value calculator 12. The control voltage value calculator 12 calculates a d-axis/q-axis control voltage value V_{dqctrl} based on the d-axis/q-axis current command value I_{dqref} output from the current command value/estimated speed input value calculator 11, the power supply voltage V_{supply}, and a d-axis/q-axis motor current value I_{dqact} output from a three-phase to two-phase converter 18.

The motor controller 100 includes the control output calculator 13. The control output calculator 13 calculates a d-axis/q-axis control duty D_{dq} based on the d-axis/q-axis control voltage value V_{dqctrl} output from the control voltage value calculator 12 and the power supply voltage V_{supply}.

The motor controller 100 includes a two-phase to three-phase converter 14. The two-phase to three-phase converter 14 calculates a U-phase/V-phase/W-phase control duty D_{UVW} based on the d-axis/q-axis control duty D_{dq} output from the control output calculator 13 and a reverse park transformation angle θᵣₑᵥₚₐᵣₖ˜ output from an electric angle estimation portion 17.

The motor controller 100 includes a speed estimation portion 15. The speed estimation portion 15 calculates an estimated speed value ω^{˜} based on the estimated speed input value ω_{c} output from the current command value/estimated speed input value calculator 11, the d-axis/q-axis control voltage value V_{dqctrl} output from the control voltage value calculator 12, and the d-axis/q-axis motor current value I_{dqact} output from the three-phase to two-phase converter 18. The speed estimation portion 15 also calculates a displaced angle Δθ in electric angle between a magnetic pole direction of the rotor 2 and a voltage applied direction of a d-axis of the vector control (i.e., dc axis). Details in calculation of the displaced angle Δθ are explained later. The calculated displaced angle Δθ is input to a motor control mode selector 20. The speed estimation portion 15 serves as an example of a quadrant estimation portion.

The motor controller 100 includes a delay compensation portion 16. The delay compensation portion 16 is configured to compensate the delay of rotation of the motor 1. The rotation of the motor 1 is typically delayed due to plural factors including arithmetic process of software and response delay of the motor 1. The delay compensation portion 16 calculates a delay compensation offset value (park transformation) θ_{offsetpark} and a delay compensation offset value (reverse park transformation) θ_{offsetrevpark} based on the estimated speed value ω^{˜} estimated by the speed estimation portion 15.

The motor controller 100 includes the electric angle estimation portion 17. The electric angle estimation portion 17 calculates a park transformation angle θₚₐᵣₖ^{˜} and a reverse park transformation angle θᵣₑᵥₚₐᵣₖ^{˜} based on the estimated speed value ω^{˜} estimated by the speed estimation portion 15 and the delay compensation offset value (park transformation) θ_{offsetpark} and the delay compensation offset value (reverse park transformation) θ_{offsetrevpark} output from the delay compensation portion 16. The electric angle estimation portion 17 serves as an example of a power supply controller.

The motor controller 100 includes the three-phase to two-phase converter 18. The three-phase to two-phase converter 18 calculates the d-axis/q-axis motor current value I_{dqact} based on the park transformation angle θₚₐᵣₖ^{˜} output from the electric angle estimation portion 17 and a U-phase/V-phase/W-phase motor current value I_{UVWact} output from the motor 1.

The motor controller 100 includes a PWM modulator 19. The PWM modulator 19 calculates an ON timing of a PWM signal PWMON_{UVW} and an OFF timing of a PWM signal PWMOFF_{UVW} based on the U-phase/V-phase/W-phase control duty D_{UVW} output from the two-phase to three-phase converter 14.

The motor controller 100 includes a driver portion. The driver portion applies a three-phase voltage to the motor 1 by driving plural switching elements of the driver portion based on the PWMON_{UVW} and the PWMOFF_{UVW} output from the PWM modulator 19. The motor 1 rotates at a speed in accordance with a period of the applied voltage.

The motor controller 100 includes the motor control mode selector 20. The motor control mode selector 20 selects a control mode of the motor 1 based on the estimated speed value ω^{˜} output from the speed estimation portion 15, the speed command value ω_{ref} output from the upper level controller, the d-axis/q-axis current command value I_{dqref} and the estimated speed input value ω_{c} output from the current command value/estimated speed input value calculator 11. The control mode of the motor 1 includes a current startup mode where the magnitude of voltage gradually increases, a one-phase power mode, an open loop-control mode, and a close-loop control mode.

The construction of the electric angle estimation portion 17 is explained in detail.

The electric angle estimation portion 17 is configured to control power supply for rotating the rotor 2 to a predetermined position at startup of the rotor 2 by powering the excitation coil 3 of a predetermined phase (in the embodiment, one phase) among three phases at startup of the rotor 2 (such powering is hereinafter referred to as one-phase power supply). The rotor 2 (magnetic pole) thus rotates to the predetermined position (stop position). The rotor 2 moves to such known predetermined position so that the rotor 2 smoothly and promptly starts in the open-loop control (not including a feedback loop) that is performed after the one-phase power supply.

In a case where a magnetic field generated from the excitation coils 3 and the magnetic pole are balanced as illustrated in FIG. 1 (such place is hereinafter referred to as a dead spot), the rotor 2 fails to rotate to the predetermined position.

The electric angle estimation portion 17 is thus configured to select the excitation coil 3 of one phase among three phases so that the one-phase power supply is performed on the selected coil 3 based on the position of the magnetic pole in a state where the rotor 2 is stopped. Additionally, the electric angle estimation portion 17 is configured to select the excitation coil 3 of one phase among three phases on which the one-phase power supply is performed so that the state where the magnetic field generated from the excitation coil 3 and the magnetic pole are balanced is not established, based on the position of the magnetic pole in a state where the rotor 2 is stopped. Specifically, the electric angle estimation portion 17 calculates the electric angle based on the estimated speed value ω^{˜} output from the speed estimation portion 15. The electric angle estimation portion 17 then corrects the electric angle based on the delay compensation offset value (park transformation) θ_{offsetpark} and the delay compensation offset value (reverse park transformation) θ_{offsetrevpark} output from the delay compensation portion 16, i.e., updates the dc axis. Such correction of the electric angle is reflected to the reverse park transformation angle θᵣₑᵥₚₐᵣₖ^{˜} output from the electric angle estimation portion 17.

Specifically, the speed estimation portion 15 is configured to estimate one quadrant among four quadrants of a plane coordinate formed by a q-axis and a d-axis orthogonal to each other, the one quadrant where the displaced angle Δθ in electric angle between a magnetic pole direction of the rotor 2 that is stopped and a voltage application direction of the d-axis of the vector control (i.e., dc axis) belongs to (i.e., configured to estimate which quadrant among four quadrants of the plane coordinate the displaced angle Δθ belongs to). The electric angle estimation portion 17 is configured to select the excitation coil 3 of one phase among three phases on which the one-phase power supply is performed in accordance with the quadrant to which the displaced angle Δθ estimated by the speed estimation portion 15 belongs.

Next, a method of estimating the quadrant to which the displaced angle Δθ (position of the magnetic field) belongs is explained. The displaced angle Δθ is calculated at the speed estimation portion 15. The speed estimation portion 15 estimates a difference (misalignment) of the estimated magnetic pole direction (dc axis) relative to the actual magnetic pole direction (i.e., as viewed from the actual magnetic pole direction).

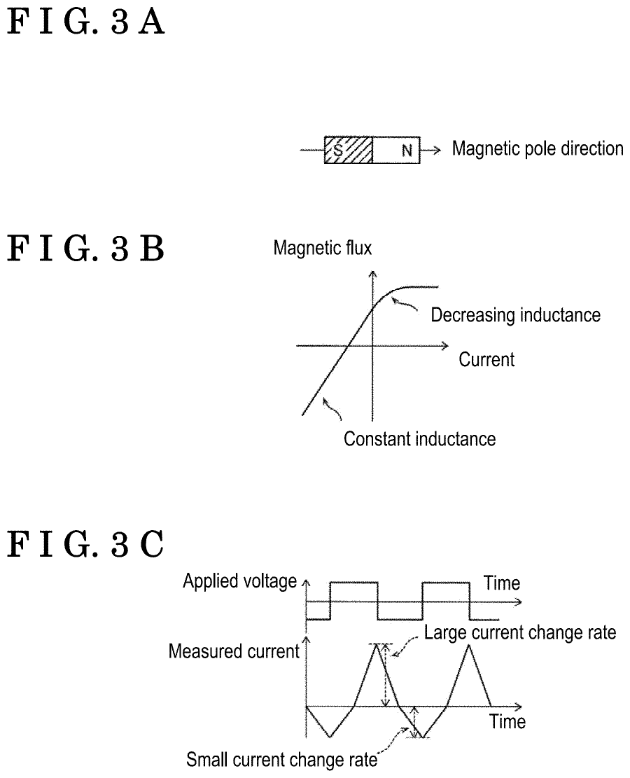

In a case where an electric current (positive current) is applied to the excitation coil 3 in the magnetic pole direction as illustrated in FIG. 3A, a magnetic flux increases as illustrated in FIG. 3B. The magnetic flux is inhibited from further increasing when the applied current reaches or exceeds a certain amount. Such state (phenomenon) is called a magnetic saturation. In the state of magnetic saturation, inductance decreases, which causes increase of current change rate. In a case where an electric current (negative current) is applied to the excitation coil 3 in a direction opposite to the magnetic pole direction, the magnetic saturation fails to occur, which leads to constant inductance. The current change rate is constant accordingly. That is, as illustrated in FIG. 3C, the current change rate increases when the positive current is applied and decreases when the negative current is applied.

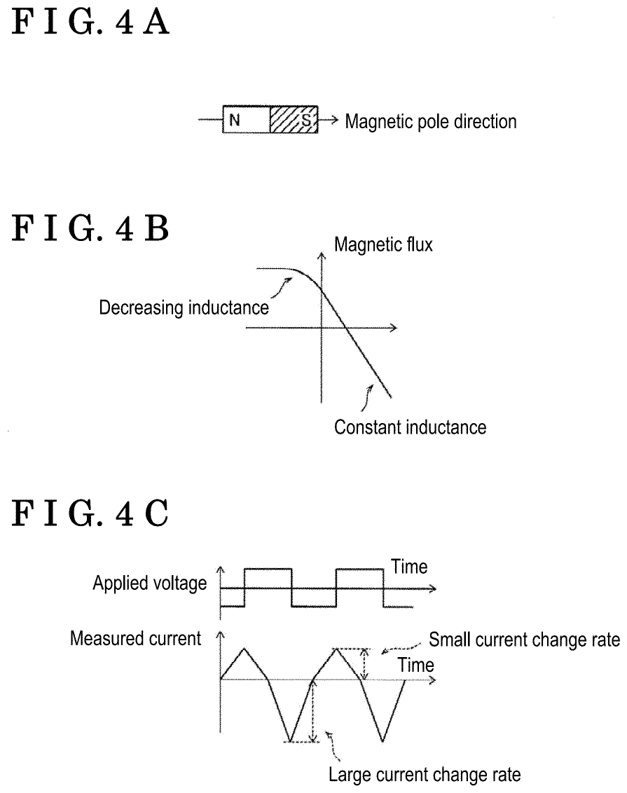

As illustrated in FIGS. 4A to 4C, in a case where the positive current is applied to the excitation coil 3 in the opposite direction to the magnetic pole direction, a reverse phenomenon from the above (i.e., the case where the positive current is applied in the magnetic pole direction) is obtained. Specifically, in a state where the positive current and the negative current are applied in the direction opposite to the magnetic pole direction, the current change rate decreases when the positive current is applied and increases when the negative current is applied. Accordingly, measuring the current change rate achieves estimation of whether the state in which the current applied direction and the magnetic pole direction match each other is satisfied.

The estimation of the magnetic pole position based on the current change rate is explained below. In the present embodiment, the speed estimation portion 15 is configured to estimate the quadrant to which the displaced angle Δθ belongs in accordance with the change rate of the current flowing through the excitation coil 3 by applying a small voltage in each of the d-axis direction and the q-axis direction of the vector control.

First, a small voltage Vd(n) is applied in the d-axis direction to add a positive current and a negative current.

Next, a current Id(n) flowing through the motor 1 is measured and acquired to measure a current change rate |(Id(n)−Id (n−1))|. In order to capture a small current change rate, a polar signal PFd(n) is decided with the following polar signal calculation formula:

PFd(n)=Σ(Vd(n)×(−1)×|(Id(n)−Id(n−1))|)

The same process as above is also applied to the q-axis. Specifically, a polar signal PFq (n) is decided with the following polar signal calculation formula:

PFq(n)=Σ(Vq(n)×(−1)×|(Id(n−1))|)

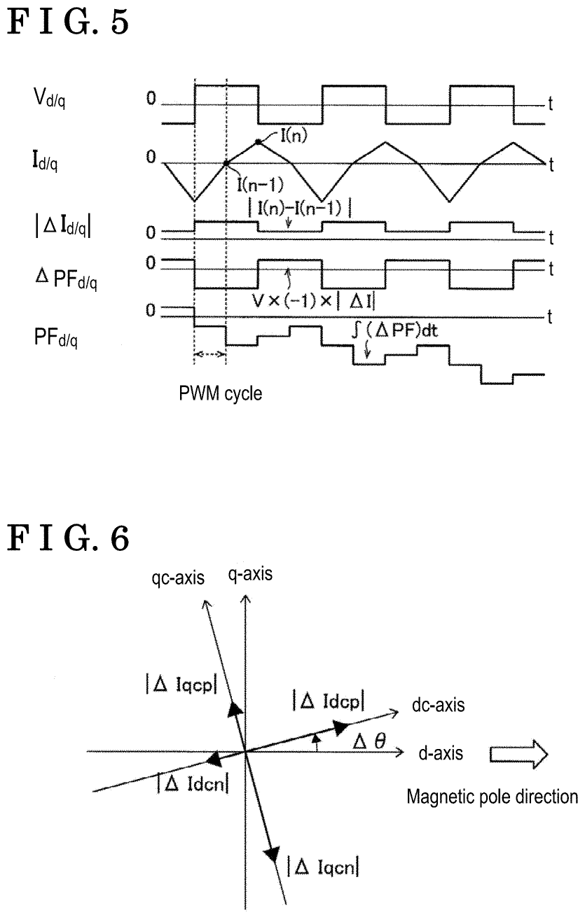

As illustrated in FIG. 5, each sampling of the current Id(n) and the current Iq(n) is performed per cycle of PWM signal, for example. The current change rate is calculated by software inside the motor controller 100. Thus, calculation of the current change rate is delayed by one cycle relative to the sampling of the current. In FIG. 5, the polar signal PFd (PFq) is negative.

In the process of estimating the magnetic pole position, the magnetic pole direction is unknown, which causes misalignment (difference) between the magnetic pole direction and the voltage application direction for the d-axis and the q-axis. A relationship between such misalignment and the polar signal is explained as below.

As illustrated in FIG. 6, the voltage application directions for the d-axis and the q-axis are defined to be a dc-axis and a qc-axis respectively. A difference (angle) between the d-axis and the dc-axis is defined to be an angle Δθ. For example, in a case where the angle Δθ is between 0 degree and 90 degrees, the positional relationship between the d-axis, the q-axis, the dc-axis, and the qc-axis is as illustrated in FIG. 6. When the current is applied in a direction closer to the magnetic pole direction (i.e., a direction where the angle Δθ is closer to zero), a current change rate |ΔIdcp| obtained when the positive current is applied in the d-axis direction is greater than a current change rate |ΔIdcn| obtained when the negative current is applied in the d-axis direction. The polar signal PFd is a positive value. Additionally, a current change rate |ΔIqcp| obtained when the positive current is applied in the q-axis direction is smaller than a current change rate |ΔIqcn| obtained when the negative current is applied in the q-axis direction. The polar signal PFq is a negative value.

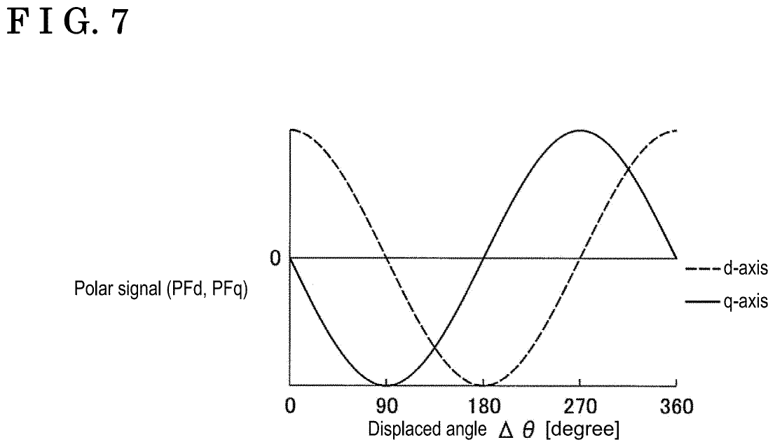

A relationship between the displaced angle Δθ and each of the polar signal of the d-axis and the polar signal of the q-axis is as shown in FIG. 7. The quadrant to which the displaced angle Δθ formed between the actual magnetic pole position (magnetic pole direction) and the voltage application direction belongs, among the four quadrants, is estimated in accordance with table 1 below.

TABLE 1

| Sign of PFd | Sign of PFq | Δθ (degree) |
|---|---|---|
| + | + | −90 ≤ Δθ < 0 |
| + | − | 0 ≤ Δθ < 90 |
| − | + | −180 ≤ Δθ < −90 |
| − | − | 90 ≤ Δθ < 180 |

In the present embodiment, the electric angle estimation portion 17 maintains (i.e., does not change) the voltage application direction of the d-axis of the vector control in a case where the displaced angle Δθ is in a range equal to or greater than zero degree and less than 90 degrees as shown in table 2 below where the rotation angle of the d-axis in the voltage application direction is indicated by “A”. The electric angle estimation portion 17 changes the voltage application direction of the d-axis to rotate by minus 90 degrees in a case where the displaced angle Δθ is in a range equal to or greater than 90 degrees and less than 180 degrees. The electric angle estimation portion 17 changes the voltage application direction of the d-axis to rotate by minus180 degrees in a case where the displaced angle Δθ is in a range equal to or greater than minus180 degrees and less than minus 90 degrees. The electric angle estimation portion 17 changes the voltage application direction of the d-axis to rotate by 90 degrees in a case where the displaced angle Δθ is in a range equal to or greater than minus 90 degrees and less than zero degree. The electric angle estimation portion 17 is thus configured to select the excitation coil 3 on which the one-phase power supply is performed.

TABLE 2

| Δθ (degree) | A (degree) | B (degree) |
|---|---|---|
| −90 ≤ Δθ < 0 | 90 | 0 ≤ B < 90 |
| 0 ≤ Δθ < 90 | 0 | 0 ≤ B < 90 |
| −180 ≤ Δθ < −90 | −180 | 0 ≤ B < 90 |
| 90 ≤ Δθ < 180 | −90 | 0 ≤ B < 90 |

Specifically, the value of the reverse park transformation angle θᵣₑᵥₚₐᵣₖ^{˜} output from the electric angle estimation portion 17 is changed in accordance with the displaced angle Δθ to rotate the voltage application direction of the d-axis.

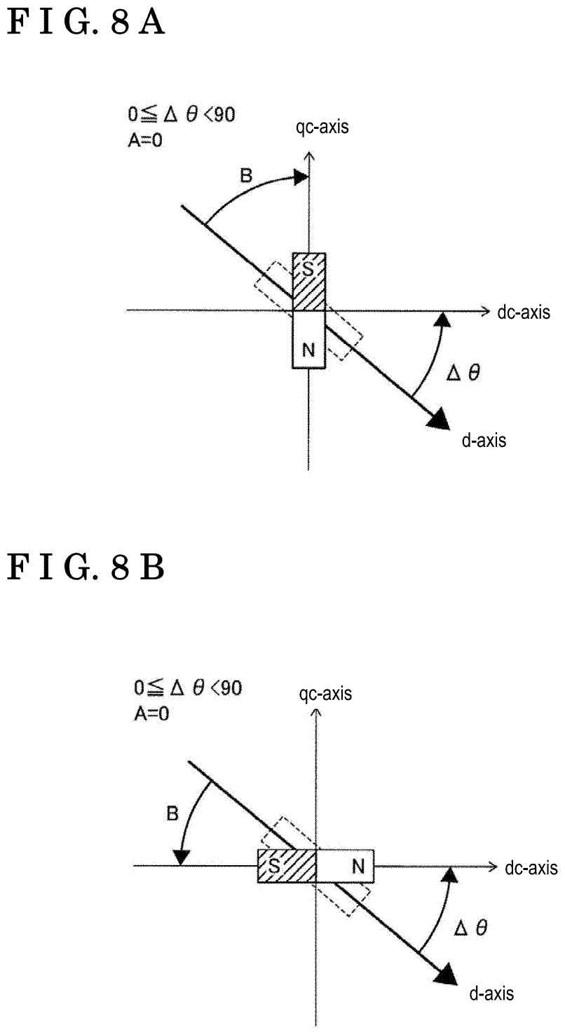

In the present embodiment, the one-phase power supply is performed by applying a positive voltage in the q-axis direction or a negative voltage in the d-axis direction. For example, in a case where the displaced angle Δθ is in a range equal to or greater than 0 degree and smaller than 90 degrees as illustrated in FIGS. 8A and 8B, the voltage application direction of the d-axis of the vector control is not changed (i.e., maintained). As illustrated in FIG. 8A, in a case where the positive voltage is applied in the q-axis direction (i.e., qc-axis), the qc-axis becomes a north magnetic pole (N-pole). The rotor 2 then rotates in a state where a south magnetic pole (S-pole) is pulled so that the power supply direction (i.e., the qc-axis) and the magnetic pole direction match each other. The rotor 2 stops at a position where the power supply direction (i.e., qc-axis) and the magnetic pole direction match each other (i.e., the rotor 2 stops at a fixed position). Similarly, as illustrated in FIG. 8B, in a case where the negative voltage is applied in the d-axis direction (i.e., dc-axis), the dc-axis becomes the S-pole. The rotor 2 rotates in a state where the N-pole is pulled so that the power supply direction (i.e., the dc-axis) and the magnetic pole direction match each other. The angle by which the magnetic pole direction (i.e., the rotor 2) rotates with the one-phase power supply (i.e., “B” in table 2) is in a range equal to or greater than 0 degree and smaller than 90 degrees.

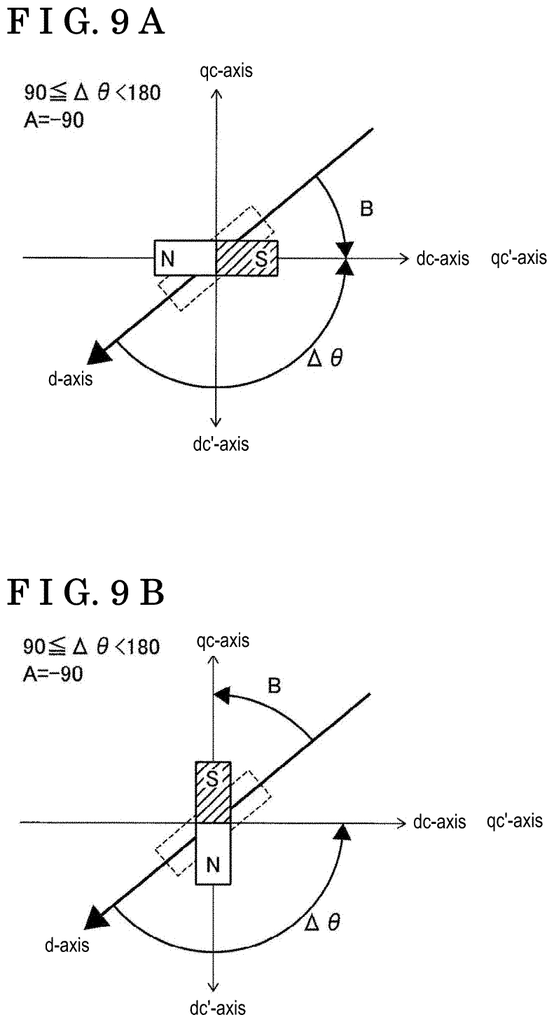

In a case where the displaced angle Δθ is in a range equal to or greater than 90 degrees and smaller than 180 degrees as illustrated in FIGS. 9A and 9B, the voltage application direction of the d-axis of the vector control is rotated by minus 90 degrees. The qc-axis after the rotation is defined to be qc′-axis and the dc-axis after the rotation is defined to be dc′-axis. The positive voltage is applied in the qc′-axis direction as illustrated in FIG. 9A or the negative voltage is applied in the dc′-axis direction as illustrated in FIG. 9B. The rotor 2 thus rotates so that the power supply direction (qc′-axis, dc′ axis) and the magnetic pole direction match each other. The angle (B in table 2) by which the magnetic pole direction (the rotor 2) rotates with the one-phase power supply is in a range equal to or greater than 0 degree and smaller than 90 degrees. In a case where the qc-axis and the dc-axis are inhibited from rotating, the magnetic pole direction rotates by an amount for the displaced angle Δθ (equal to or greater than 90 degrees and smaller than 180 degrees). The power supply time is thus elongated, which increases power consumption. In the present embodiment, the qc-axis and the dc-axis are rotated so that the power supply time decreases, which leads to reduced power consumption.

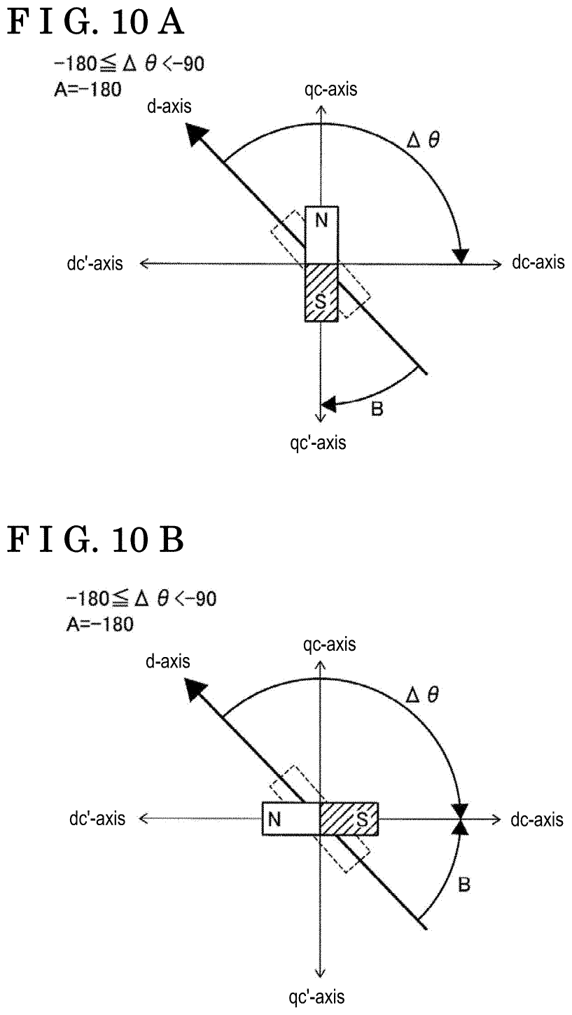

In a case where the displaced angle Δθ is in a range equal to or greater than minus 180 degrees and smaller than minus 90 degrees as illustrated in FIGS. 10A and 10B, the voltage application direction of the d-axis of the vector control is rotated by minus 180 degrees. The positive voltage is applied in the qc′-axis direction as illustrated in FIG. 10A or the negative voltage is applied in the dc′-axis direction as illustrated in FIG. 10B. The rotor 2 thus rotates so that the power supply direction (qc′-axis, dc′-axis) and the magnetic pole direction match each other. The angle by which the magnetic pole direction (the rotor 2) rotates with the one-phase power supply (B in table 2) is in a range equal to or greater than 0 degree and smaller than 90 degrees. The qc-axis and the dc-axis are rotated to reduce the power supply time, which leads to reduced power consumption.

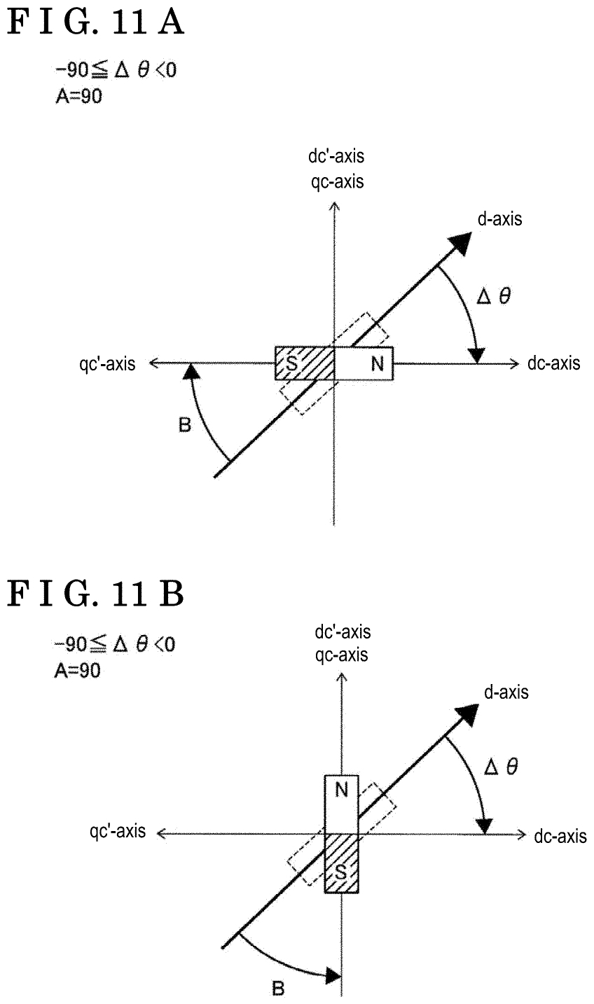

In a case where the displaced angle Δθ is in a range equal to or greater than minus 90 degrees and smaller than 0 degree as illustrated in FIGS. 11A and 11B, the voltage application direction of the d-axis of the vector control is rotated by 90 degrees. The positive voltage is applied in the qc′-axis direction as illustrated in FIG. 11A or the negative voltage is applied in the dc′-axis direction as illustrated in FIG. 11B. The rotor 2 thus rotates so that the power supply direction (qc′-axis, dc′-axis) and the magnetic pole direction match each other. The angle by which the magnetic pole direction (the rotor 2) rotates with the one-phase power supply (B in table 2) is in a range equal to or greater than 0 degree and smaller than 90 degrees. The qc-axis and the dc-axis are rotated to reduce the power supply time, which leads to reduced power consumption.

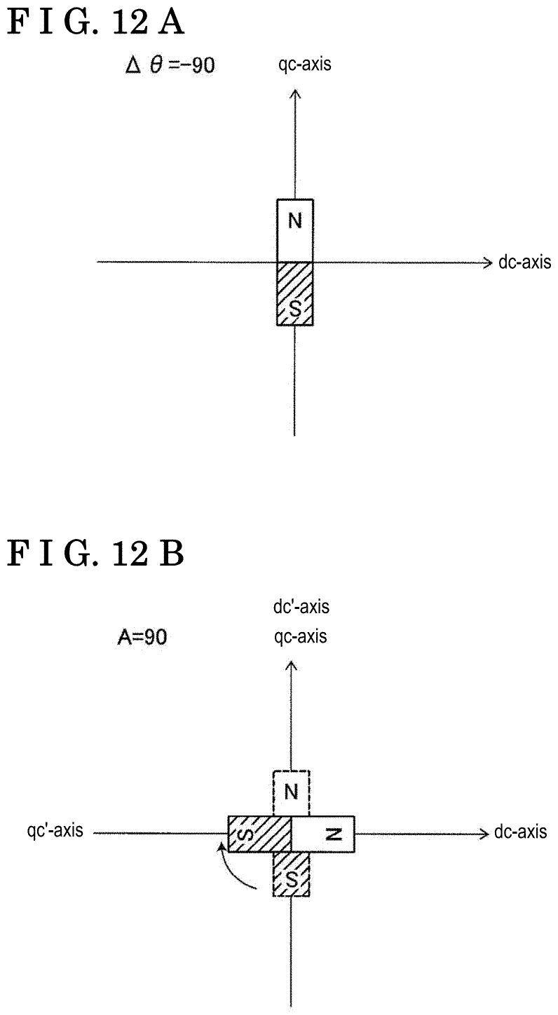

A case where the magnetic pole is positioned in the dead spot is explained as below. As illustrated in FIG. 12A, the qc-axis becomes the N-pole with the application of the positive voltage to the qc-axis in a state where the magnetic pole direction (N-pole direction) and the qc-axis are aligned with each other. The magnetic pole is thus inhibited from rotating to the predetermined position (fixed position) with the one-phase power supply. In FIG. 12A, the displaced angle Δθ is minus 90 degrees. The voltage application direction of the d-axis of the vector control is then rotated by 90 degrees as illustrated in FIG. 12B. The positive voltage is applied in the qc′-axis direction. The magnetic pole is thus rotated to the predetermined position (fixed position). The magnetic pole is also rotatable to the predetermined position (fixed position) by the application of the negative voltage in the dc′-axis direction.

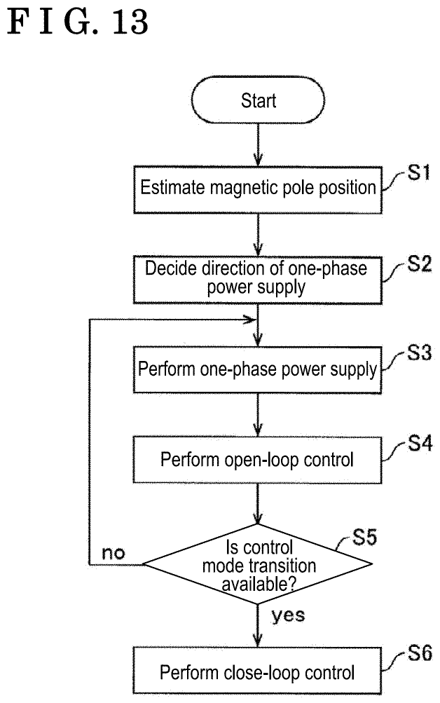

The operation of the motor controller 100 is explained with reference to FIG. 13.

The magnetic pole position (magnetic pole direction) is estimated in a state where the rotor 2 is stopped at step S1. Specifically, the estimation of the quadrant to which the displaced angle Δθ in electric angle between the magnetic pole direction and the voltage application direction of the d-axis of the vector control belongs is performed.

Next, the direction of the one-phase power supply is decided at step S2 in accordance with the quadrant estimated at step S1. Specifically, the voltage application direction of the d-axis is selected and rotated on a basis of the displaced angle Δθ as shown in table 2. The estimation of the quadrant and the rotation of the voltage application direction of the d-axis are performed by software and are thus achievable without additional sensors or hardware.

The one-phase power supply (i.e., the positive voltage application to the qc-axis or the negative voltage application to the dc-axis) is performed at step S3. The open-loop control is then performed at step S4.

Whether transition of the control mode to the close-loop control is possible (available) is determined on a basis of induced voltage generated at the excitation coil 3 at step S5.

When the positive determination is made at step S5, the close-loop control is performed at step S6. When the negative determination is made at step S5, the operation at step S3 is then performed.

In the present embodiment, when the magnetic pole of the rotor 2 is arranged at a position being balanced with the magnetic field generated from the excitation coil 3 on which the one-phase power supply is performed (i.e., the magnetic pole of the rotor 2 is in the dead spot), the excitation coil 3 that is inhibited from causing the magnetic pole of the rotor 2 to be positioned in the dead spot is selectable as the coil on which the one-phase power supply is performed. The rotor 2 is restrained from being stepped out due to balancing between the magnetic pole of the rotor 2 and the magnetic field generated from the excitation coil 3 with the one-phase power supply.

Additionally, the rotor 2 is securely inhibited from not rotating to the predetermined position that may be caused by balancing between the magnetic pole of the rotor 2 and the magnetic field generated from the excitation coil 3 with the one-phase power supply. That is, the rotor 2 securely rotates to the predetermined position.

In the present embodiment, the quadrant to which the displaced angle Δθ belongs is estimated before startup of the rotor 2. Whether the magnetic pole of the rotor 2 is arranged in the dead spot is thus determinable.

The angle formed between the magnetic pole direction of the rotor 2 and the voltage application direction of the d-axis of the vector control is made smaller than 90 degrees, which decreases the rotation angle of the rotor 2 by which the rotor 2 rotates with the one-phase power supply (i.e., an angle by which the rotor 2 rotates to stop at the predetermined position). Time for the one-phase power supply and power consumption are thus reduced. Additionally, possible noise and oscillation which may possibly occur due to rotation of the rotor 2 by the one-phase power supply is reduced.

In the present embodiment, the current change rate differs depending on the displaced angle Δθ. The quadrant to which the displaced angle Δθ belongs is thus easily estimated on a basis of the current change rate.

In the embodiment, the magnetic pole position is unable to be detected when the motor 1 serving as the sensor-less brushless motor is stopped. The estimation of the magnetic pole position (the displaced angle Δθ) by the speed estimation portion 15 is thus effective for restraining the rotor 2 from stepping out.

In the embodiment, the application of the positive voltage in the q-axis direction achieves the N-pole formed in the q-axis direction. The S-pole direction of the rotor 2 is thus aligned with the q-axis direction with the rotation angle of the rotor 2 being less than 90 degrees. That is, the rotor 2 is stopped at the predetermined position with the rotation angle being smaller than 90 degrees. Similarly, the application of the negative voltage in the d-axis direction achieves the S-pole formed in the d-axis direction. The N-pole direction of the rotor 2 is thus aligned with the d-axis direction with the rotation angle of the rotor 2 being less than 90 degrees. That is, the rotor 2 is stopped at the predetermined position with the rotation angle being smaller than 90 degrees.

The aforementioned disclosure may be appropriately changed or modified.

For example, the motor controller 100 of the motor 1 is employed for the electric water pump in the above explanation. The motor controller 100 of the motor 1 may be also employed for equipment or devices other than electric water pumps.

In the above explanation, the phase of the excitation coil on which the one-phase power supply is performed is selected on a basis of the quadrant (quadrant in the magnetic pole direction) to which the displaced angle belongs. Alternatively, the magnetic pole direction itself may be estimated and the phase of the excitation coil on which the one-phase power supply is performed may be selected in accordance with the estimated magnetic pole direction.

In the above explanation, the quadrant (quadrant in the magnetic pole direction) to which the displaced angle belongs is estimated on a basis of the current change rate of the current flowing through the excitation coil by the application of small voltage in the d-axis direction and the q-axis direction of the vector control. The quadrant (quadrant in the magnetic pole direction) to which the displaced angle belongs may be estimated by other methods than the above.

In the above explanation, the motor is controlled with the vector control. Alternatively, the phase of the excitation coil on which the one-phase power supply is performed is selectable in accordance with the magnetic pole direction of the motor that is stopped and that is controlled with other control methods than the vector control.

In the above explanation, the one-phase power supply is performed to rotate the rotor to the predetermined position at startup of the rotor by the power supply to the excitation coil of one phase among three phases. Alternatively, two-phase (or three-phase) power supply may be performed to rotate the rotor to the predetermined position at startup of the rotor by the power supply to the excitation coils of two (or three) phases among three phases. The rotor is stopped at the predetermined position accordingly.

According to the disclosure, the motor controller 100 includes the electric angle estimation portion 17 (power supply controller) controlling a power supply to rotate the rotor 2 to a predetermined position by supplying power to the excitation coil 3 of a predetermined phase among excitation coils 3 of three phases of the rotor 2 at startup of the rotor 2, the electric angle estimation portion 17 selecting the excitation coil 3 of the predetermined phase to which power is supplied in accordance with a position of a magnetic pole of the rotor 2 in a state where the rotor 2 is stopped.

Additionally, the electric angle estimation portion 17 selects the excitation coil 3 of the predetermined phase to which power is supplied while avoiding a state where a magnetic field generated from the excitation coil 3 and the magnetic pole of the rotor 2 are balanced in accordance with the position of the magnetic pole of the rotor 2 in a state where the rotor 2 is stopped.

Further, according to the disclosure, the rotor 2 is controlled to rotate by a vector control. The motor controller 100 further includes the speed estimation portion 15 (quadrant estimation portion) that estimates one quadrant among four quadrants of a plane coordinate formed by a q-axis and a d-axis of the vector control orthogonal to each other, the one quadrant to which the displaced angle Δθ in an electric angle between a magnetic pole direction of the rotor 2 that is stopped and a voltage application direction of the d-axis of the vector control belongs. The electric angle estimation portion 17 is configured to select the excitation coil 3 of the predetermined phase to which power is supplied in accordance with the estimated quadrant which is estimated by the q speed estimation portion 15 and to which the displaced angle belongs.

Furthermore, the electric angle estimation portion 17 is configured to select the excitation coil 3 of the predetermined phase to which power is supplied by maintaining the voltage application direction of the d-axis of the vector control in a case where the displaced angle Δθ is in a range equal to or greater than zero degree and smaller than 90 degrees, rotating the voltage application direction of the d-axis by minus 90 degrees in a case where the displaced angle Δθ is in a range equal to or greater than 90 degrees and smaller than 180 degrees, rotating the voltage application direction of the d-axis by minus 180 degrees in a case where the displaced angle Δθ is in a range equal to or greater than minus 180 degrees and smaller than minus 90 degrees, and rotating the voltage application direction of the d-axis by 90 degrees in a case where the displaced angle Δθ is in a range equal to or greater than minus 90 degrees and smaller than zero degree.

Furthermore, the speed estimation portion 15 is configured to estimate the quadrant to which the displaced angle Δθ belongs in accordance with a change rate of a current flowing through the excitation coil 3 by applying a small voltage in each direction of the d-axis and the q-axis of the vector control.

According to the disclosure, the motor controller 100 including the quadrant estimation portion (speed estimation portion 15) is configured to control a sensor-less brushless motor.

The motor 1 serving as the sensor-less brushless motor is unable to detect the magnetic pole position when the motor 1 is stopped. The estimation of the magnetic pole position (the displaced angle Δθ) by the quadrant estimation portion is thus effective for restraining the rotor 2 from stepping out.

Additionally, the motor controller 100 including the quadrant estimation portion (speed estimation portion 15) is configured to supply power by applying the positive voltage in the q-axis direction or applying the negative voltage in the d-axis direction.

The application of the positive voltage in the q-axis direction achieves the N-pole formed in the q-axis direction. The S-pole direction of the rotor 2 is thus aligned with the q-axis direction with the rotation angle of the rotor 2 being less than 90 degrees. That is, the rotor 2 is stopped at the predetermined position with the rotation angle being smaller than 90 degrees. Similarly, the application of the negative voltage in the d-axis direction achieves the S-pole formed in the d-axis direction. The N-pole direction of the rotor 2 is thus aligned with the d-axis direction with the rotation angle of the rotor 2 being less than 90 degrees. That is, the rotor 2 is stopped at the predetermined position with the rotation angle being smaller than 90 degrees.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A motor controller comprising:
a power supply controller controlling a power supply to rotate a rotor to a predetermined position by supplying power to an excitation coil of a predetermined phase among excitation coils of three phases of the rotor at startup of the rotor;
the power supply controller selecting the excitation coil of the predetermined phase to which power is supplied in accordance with a position of a magnetic pole of the rotor in a state where the rotor is stopped.

2. The motor controller according to claim 1, wherein the power supply controller selects the excitation coil of the predetermined phase to which power is supplied while avoiding a state where a magnetic field generated from the excitation coil and the magnetic pole of the rotor are balanced in accordance with the position of the magnetic pole of the rotor in a state where the rotor is stopped.

3. The motor controller according to claim 1, wherein the rotor is controlled to rotate by a vector control,
the motor controller further including a quadrant estimation portion that estimates one quadrant among four quadrants of a plane coordinate formed by a q-axis and a d-axis of the vector control orthogonal to each other, the one quadrant to which a displaced angle in an electric angle between a magnetic pole direction of the rotor that is stopped and a voltage application direction of the d-axis of the vector control belongs,
the power supply controller being configured to select the excitation coil of the predetermined phase to which power is supplied in accordance with the estimated quadrant which is estimated by the quadrant estimation portion and to which the displaced angle belongs.

4. The motor controller according to claim 3, wherein the power supply controller is configured to select the excitation coil of the predetermined phase to which power is supplied by maintaining the voltage application direction of the d-axis of the vector control in a case where the displaced angle is in a range equal to or greater than zero degree and smaller than 90 degrees, rotating the voltage application direction of the d-axis by minus 90 degrees in a case where the displaced angle is in a range equal to or greater than 90 degrees and smaller than 180 degrees, rotating the voltage application direction of the d-axis by minus 180 degrees in a case where the displaced angle is in a range equal to or greater than minus 180 degrees and smaller than minus 90 degrees, and rotating the voltage application direction of the d-axis by 90 degrees in a case where the displaced angle is in a range equal to or greater than minus 90 degrees and smaller than zero degree.

5. The motor controller according to claim 3, wherein the quadrant estimation portion is configured to estimate the quadrant to which the displaced angle belongs in accordance with a change rate of a current flowing through the excitation coil by applying a small voltage in each direction of the d-axis and the q-axis of the vector control.
